(19) United States
(12) Patent Application Publication
(10) Pub. No.: US 2020/0398968 A1
(43) Pub. Date: Dec. 24, 2020

(54) Integrated Pultruded Composite Profiles and Method for Making Same

(71) Applicant: TSC, LLC, Mojave, CA (US)

(72) Inventors: Rob Sjostedt, Tehachapi, CA (US); Steve Ericson, Lancaster, CA (US); Paul Nicholas, Burbank, CA (US)

(73) Assignee: TSC, LLC, Mojave, CA (US)

(21) Appl. No.: 16/905,132

(22) Filed: Jun. 18, 2020

Related U.S. Application Data
(60) Provisional application No. 62/864,285, filed on Jun. 20, 2019.
(60) Provisional application No. 62/864,250, filed on Jun. 20, 2019.
(60) Provisional application No. 62/864,272, filed on Jun. 20, 2019.

(51) Int. Cl. B64C 3/18; B64C 3/26; B29D 99/00; B29C 65/00

(52) U.S. Cl. CPC B64C 3/185; B64C 3/26; B29L 2031/3085; B29C 66/7392; B29D 99/0014

(57) ABSTRACT

Integrated pultruded composite profiles such as rotor wings and blades for electric vertical take-off and landing aircraft, light helicopters, wind turbines, and other rotor wing applications and integrated design and processing methods for making same are disclosed. The present invention provides a plurality of web ribs for stiffening and supporting an outer skin which can comprise fabric plies, a metallic skin, or a thermoplastic composite skin. A process and method to continuously pultrude integrated composite airfoil profile with variable aerodynamic twist is also disclosed. Utilization of a stranded metallic wire rope that enables the leading edge weight to be continuously in-situ fed into the pultrusion process and effectively retained in the pultruded product is also disclosed. Utilization of fiber reinforcement impregnated with matrix resin that is loaded with high density powder for the leading edge weight is also disclosed.

### CROSS-REFERENCE TO RELATED APPLICATIONS

This application claims priority under 35 USC Section 119(e) to co-pending U.S. Provisional Patent Application No. 62/864,250 filed on Jun. 20, 2019, the entire disclosure of which is incorporated herein by reference. This application also claims priority under 35 USC Section 119(e) to co-pending U.S. Provisional Patent Application No. 62/864,272 filed on Jun. 20, 2019, the entire disclosure of which is incorporated herein by reference. And, this application also claims priority under 35 USC Section 119(e) to co-pending U.S. Provisional Patent Application No. 62/864,285 filed on Jun. 20, 2019, the entire disclosure of which is incorporated herein by reference.

### FIELD OF THE INVENTION

This invention relates generally to integrated pultruded composite profiles, such as rotor wings and blades, and methods for making same.

### BACKGROUND OF THE INVENTION

Pultrusion is a continuous composite manufacturing process that has long been recognized for high rate and low cost production products. Fibers such as fiberglass or carbon in various forms are mechanically pulled through a resin bath, shaping tooling, and resin squeeze-out tooling and then pass through a heated steel die that cures the raw materials into a solid profile having utility for various applications. For example, fiberglass pultrusions have been commonly used for products such as ladder rails, chemical plant handrails and grating, tool handles, and highway delineator strips.

Over time, pultrusion capability has evolved from making simple monolithic fiberglass profiles to more complex shapes and applications using a variety of fibers and resins. The capability to pultrude hollow cross section parts is also emerging. For example, there have been low volume demonstrations of hollow airfoil shapes. Solid cross section unidirectional carbon pultrusions are being used in wind turbine blade spars and large, developmental aircraft wing spars.

Previously, composite rotor blades for helicopters and other rotor wing applications have typically been hand laminated from a variety of aerospace-grade composite materials and cured in molds, which would be classified as a batch process. Examples of these hand-laminated batch processes are pre-preg autoclave and oven cure, wet lay-up, and vacuum assist resin injection.

However, emerging new markets such as urban air transportation using electric vertical take-off and landing (“eVTOL”) aircraft demand high-volume, advanced-composite production. For example, an urban air mobility vehicle, such as an eVTOL, for serving just a few major metropolitan cities needs to be produced in quantities of more than two-thousand ship sets per year. Such production demand requires one ship set per hour production on a single shift standard work week basis. A typical urban air mobility vehicle has multiple blades so the required blade production rate is even higher than the basic airframe. These factors drive the rotor blade design for such applications to constant cord and constant cross section designs for production and allowing processes for high volume manufacture. It would not be practical to expand conventional batch processing methods for very high rate production at these levels due to the number of molds and fabricators required.

In addition, in many of these applications it is also necessary to incorporate a metallic leading edge weight into the composite airfoil structure. The leading edge weight is commonly round steel rod stock that is either bonded into the composite airfoil shape as it is laminated by conventional means or in-situ incorporated into the airfoil as it is pultruded.

Several options are common in industry to incorporate a metallic leading edge weight into a laminated or pultruded airfoil section, all of which have known limitations.

One option is to pultrude the composite profile with a hole in the leading edge for a steel rod to be inserted later and bonded in place. This approach involves a secondary assembly process and it is difficult to insure the steel rod is effectively bonded in place for the full length of the rotor blade.

A second option is to insert the steel rod in-situ into the pultrusion process so it becomes an integrated part of the airfoil profile. This approach can be difficult depending on the size of the metallic rod and weight required. If the rod is large in diameter, then it is typically received as a twenty foot length of bar stock. Steel rod must be grit blasted and prepared for insertion to achieve an acceptable bond to the composite airfoil. The pultrusion infeed tooling also must be designed to automatically insert twenty foot lengths of metallic rod end-to-end. And, the locations of the rod-to-rod joints must be managed because where one rod buts up to another would vary in gap. Further a flightworthy and certified product could not have a joint in the steel rod in the mid-span of the profile.

Normally, epoxy pultrusions require a secondary, oven post-cure to fully cross link the matrix polymer. Quite often, one of skill in the art would affect roughly eighty percent of the product cure with the pultrusion process for optimal line speed and post cure the product off line. When the airfoil section is post cured in an oven, the epoxy or other suitable matrix resin takes a new set as the cure is completed. The amount of twist induced may have to be greater than the desired twist to handle spring-back depending on the matrix resin used.

Therefore, there is a need for integrated pultruded composite profiles and a method for making same, including pultruded composite profiles such as airfoil profiles for rotor wings and blades for eVTOLs, light helicopters, wind turbines, and other rotor wing applications that provides for high volume, low cost and consistent production by continuous automated processing.

In addition, there is a need for a solution for inserting metallic leading edge weights into a pultruded airfoil profile to overcome the limitations of the prior art.

In addition because most rotor blades have aerodynamic twist incorporated along the blade length to optimize performance, it is desirable to be able to produce blades that incorporate the desired aerodynamic twist as the blades are produced continuously.

These and other needs are addressed by one or more aspects of the present invention.

### BRIEF SUMMARY OF THE INVENTION

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. In addition, features and advantages of the various embodiments can be combined in various respects.

A pultruded integrated composite profile according to the present invention has spar structure, a leading edge weight, and other structural features for a functional rotor wing blade. In one embodiment, the leading edge weight comprises a metallic leading edge weight and a carbon fiber fill leading edge weight.

In one embodiment, fabric plies also encapsulate the entire integrated composite airfoil profile and are supported by skin stiffening web ribs. In another embodiment, the outer skin comprises a metal sheet skin. In yet another embodiment, a thermoplastic composite skin is formed and bonded over the airfoil profile.

In one embodiment, the integrated composite airfoil profile is cut to length and joined with a root end fitting that facilitates attachment to a rotor hub assembly. Tip and root insert ribs close the open ends of the integrated composite airfoil profile. The leading edge weight is integrated into the integrated composite airfoil profile during the pultrusion process. In one embodiment, the leading edge weight can be included with the tip close-out rib. In another embodiment, an additional weight can be incorporated into the tip close-out rib for further balancing of the blade.

A metallic leading edge weight is required in rotor blade applications for flight dynamics. Traditional laminated rotor blades use a steel rod as the leading edge weight which is difficult to pultrude and reliably retain in the blade. Therefore, in a further embodiment, the use of a stranded metallic wire rope that enables the leading edge weight to be continuously in-situ fed into the pultrusion process and effectively retained in the integrated composite airfoil profile is also disclosed. An advantage of the wire rope is it is available in long lengths and flexible so it can be coiled on spools. Consequently, there are no joints to contend with in the airfoil profile.

In yet another embodiment, inserting a high density metallic powder or particles into a pultrusion resin mix creates a leading edge weight that can be continuously in-situ fed into the pultrusion process and effectively retained in the pultruded product.

In various embodiments of the present invention, additional features and options can be incorporated into the airfoil profile such as lightning strike protection, surface cosmetics and environmental protection, leading edge erosion protection, and additional root end doublers.

In a further embodiment, a gripper puller and method to create aerodynamic twist in a airfoil profile is disclosed. While aerodynamic twist is not required for all rotor wing designs, it is desirable in many designs because it can offer flight performance enhancement. The amount of desirable twist is generally between 0 and 15 degrees from root to tip. Therefore, a method and puller to continuously pultrude airfoil profiles with variable aerodynamic twist are also disclosed.

Accordingly, one or more embodiments of the present invention overcomes one or more of the shortcomings of the known prior art.

For example, in one embodiment, an integrated composite airfoil profile comprises a spar structure comprising a spar web and a spar box; a leading edge weight; an outer skin; a plurality of web ribs for stiffening and supporting the outer skin; and wherein the leading edge weight, the spar structure, and the plurality of web ribs are integrated during pultrusion to form the integrated composite airfoil profile.

In this embodiment, the integrated composite airfoil profile can further comprise a metallic leading edge weight portion and a carbon fiber fill leading edge weight portion; wherein the metallic leading edge weight portion further comprises a metallic stranded wire rope; wherein the metallic leading edge weight portion further comprises a plurality of wire rods; wherein the outer skin comprises a composite fabric ply and wherein the composite fabric ply is wrapped around the leading edge weight and the spar structure; wherein the fabric ply comprises a non-woven carbon fiber fabric; a root end fitting for connection of the integrated composite airfoil profile to a rotor hub of an aircraft, the root end fitting comprising a doubler plate and a root end stub; wherein the doubler plate comprises a metallic doubler plate; wherein the doubler plate comprises a composite doubler plate; wherein the outer skin comprises a metal skin, and wherein the metal skin is bonded to the leading edge weight and the spar structure; wherein the outer skin comprises a thermoplastic composite skin and wherein the thermoplastic composite skin is bonded to the leading edge weight and the spar structure; wherein the thermoplastic composite skin further comprises an outer side and an inner side, the inner side comprising a synthetic veil material; wherein the leading edge weight comprises a fiber reinforcement impregnated with matrix resin; further comprising a wire mesh screen for lightning strike protection; further comprising an exterior synthetic surfacing veils; further comprising a foam insert to support the skin stiffening web ribs; further comprising a metallic leading edge cuff, wherein the metallic leading edge cuff is bonded to the leading edge weight and the spar structure.

In another example embodiment, a pultrusion tooling system for pultruding an integrated composite airfoil profile comprises: a leading edge reinforcement station; a leading edge weight die; a first resin impregnation station for injection of a matrix resin loaded with high density powder into the leading edge weight die; an airfoil reinforcement station; an airfoil die; and a second resin impregnation station for injection of a matrix resin not loaded with high density powder into the airfoil die.

In another example embodiment, a gripper puller for creating aerodynamic twist in an airfoil profile comprises: a puller frame; a gripper frame, wherein the gripper frame is attached to the puller frame with a bearing, and wherein the gripper frame rotates relative to the puller frame; a gripper jaw to secure an airfoil profile in the gripper frame; a linear guide rail for supporting the gripper frame and puller frame; a pull actuator for driving the gripper frame and the puller frame along the linear guide rail; a twist actuator for rotating the gripper frame; and wherein as the pull actuator drives the gripper frame and puller frame along the linear rail, the twist actuator rotates the gripper frame causing the airfoil profile to twist to build aerodynamic twist into the airfoil profile.

Other objects, features, and advantages of the present invention will become apparent upon consideration of the following detailed description and the accompanying drawings.

### BRIEF DESCRIPTION OF THE DRAWINGS

FIG. 1 illustrates a cross-sectional side-view of an example integrated composite airfoil profile pultruded as one integrated composite according to an example embodiment of the invention.

FIG. 2 illustrates multiple views of an example root end fitting to facilitate connection of an integrated composite airfoil profile to a rotor hub assembly of an aircraft with fasteners.

FIG. 3 illustrates a cross-sectional side-view of an alternative integrated composite airfoil profile where the outer skin comprises a metal skin that is bonded around a pultruded leading edge and spar web and box to create an integrated composite airfoil profile.

FIG. 4 illustrates a cross-sectional side-view of a further alternative integrated composite airfoil profile where the outer skin comprises a thermoplastic composite skin that is formed and bonded over the pultruded leading edge weight and spar web and box.

FIG. 5 illustrates a cross-sectional side-view of another alternative integrated composite airfoil profile where the leading edge weight comprises fiber reinforcement impregnated with matrix resin that is loaded with a high density powder.

FIG. 6 illustrates a pultrusion tooling system for making an integrated composite airfoil profile according to the present invention.

FIG. 7 illustrates a front view of a gripper puller that can be utilized to build aerodynamic twist into an airfoil profile.

FIG. 8 illustrates a rear view of a gripper puller that can be utilized to build aerodynamic twist into an airfoil profile.

FIG. 9 illustrates a front view of a further embodiment with two gripper pullers used in tandem to build aerodynamic twist into a pultruded airfoil profile.

### DETAILED DESCRIPTION OF THE INVENTION

The following is a detailed description of exemplary embodiments to illustrate the principles of the invention. The embodiments are provided to illustrate aspects of the invention, but the invention is not limited to any embodiment. The scope of the invention encompasses numerous alternatives, modifications, and equivalents. The scope of the invention is limited only by the claims.

While numerous specific details are set forth in the following description to provide a thorough understanding of the invention, the invention may be practiced according to the claims without some or all of these specific details.

Various embodiments will be described in detail with reference to the accompanying drawings. Wherever possible, the same reference numbers are used throughout the drawings to refer to the same or like parts. References made to particular examples and implementations are for illustrative purposes, and are not intended to limit the scope of the claims.

Pultruded Airfoil

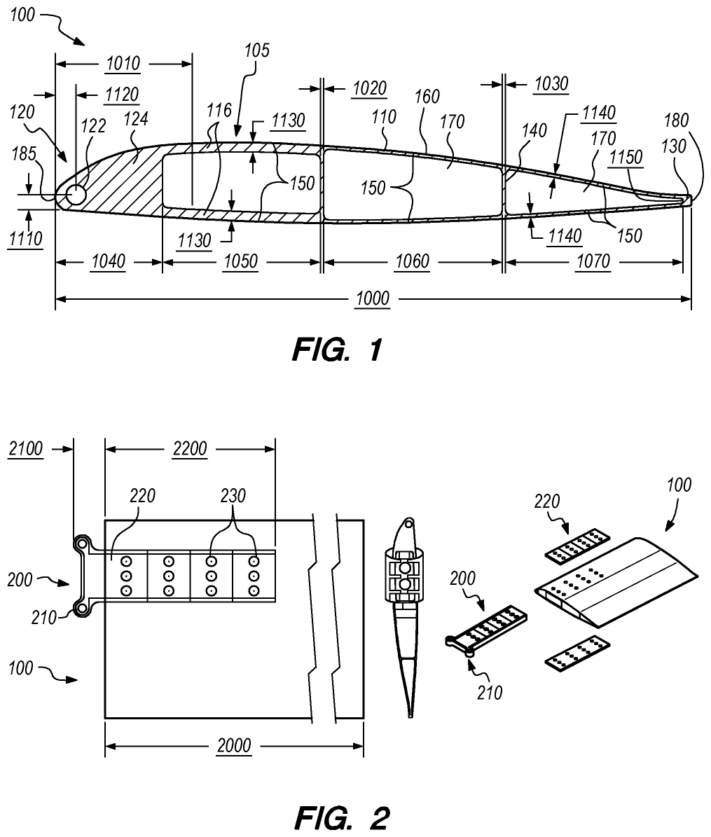

FIG. 1 illustrates an integrated composite airfoil profile 100 pultruded as one integrated composite assembly without secondary bonding. As shown in FIG. 1, the integrated composite airfoil profile 100 includes spar structure 105 comprising spar web 110, spar box 116, leading edge weight 120, trailing edge weight 130, skin stiffening web ribs 140, and outer skin 150. In this embodiment, skin stiffening web ribs 140 support outer skin 150. The skin stiffening ribs 140 are built into integrated composite airfoil profile 100 as it is pultruded. Thus, no secondary composite processing, composite fabrication or composite bonding is required for the integrated composite airfoil profile 100, which is important for high volume production.

In one embodiment, the leading edge weight 120 comprises a metallic leading edge weight portion 122 and carbon fiber fill leading edge weight portion 124. In one embodiment, the metallic leading edge weight 122 can comprise 0.375 inch steel wire rope, and the carbon fiber fill leading edge weight portion 124 can comprise solid 24K carbon fiber fill. In another embodiment, glass roving or carbon tow fibers are used for spar box 116, and carbon fiber fill is used for leading edge weight portion 124 and trailing edge weight 130.

In one embodiment, the outer skin 150 comprises composite fabric plies 160 that are wrapped around spar web 110 and spar box 116 that produce hollow sections 170 of integrated composite airfoil profile 100. In one embodiment, the fabric plies 160 encapsulate the entire integrated composite airfoil profile 100. A variety of composite fabric options can be used for the fabric plies 160 such as woven cloth or multi-axial stitch-bonded non-woven fabrics. In one embodiment, 3K triaxial non-woven carbon fiber fabric is used for the fabric plies 160.

In yet another embodiment, fibers at plus or minus 45 degrees in the fabric plies 160 are used to handle torsional and chord-wise loads. In addition, unidirectional rovings or tow in the span-wise direction can be added to handle bending loads. The fibers at plus or minus 45 degrees also provide the strength necessary for pultruding the integrated composite airfoil profile 100.

In various other embodiments, the integrated composite airfoil profile 100 can be made with fibers such as fiberglass, carbon fibers, or aramid fibers and matrix resin such as epoxy, vinyl ester, or polyester. In a further embodiment other pultrudable resin systems and fibers can be used.

As shown in FIG. 1, in one embodiment, the integrated composite airfoil profile 100 also has dimensions 1000, 1010, 1020, 1030, 1040, 1050, 1060, 1070, 1100, 1110, 1120, 1130, 1140, and 1150. In one embodiment, integrated composite airfoil profile 100 has dimension 1000 of approximately 12 inches, dimension 1010 of approximately 3 inches, dimension 1020 of approximately 0.05 inches, dimension 1030 of approximately 0.05 inches, dimension 1040 of approximately 2 inches, dimension 1050 of approximately 3 inches, dimension 1060 of approximately 3.37 inches, dimension 1070 of approximately 3.37 inches, dimension 1100 of approximately 1.22 inches, dimension 1120 of approximately 0.4 inches, dimension 1130 of approximately 0.187 inches, dimension 1140 of approximately 0.05 inches, and dimension 1150 of approximately 0.05 inches.

Metallic Leading Edge Weight

In a further embodiment, the metallic leading edge weight portion 122 can be continuously inserted into the pultrusion as the integrated composite airfoil profile 100 is produced. A pultrusion method and pultrusion tooling system for pultrusion of rotor blades and other hollow and solid pultruded profiles having non-uniform cross sections such as a thick cross section leading edge weight, and products made by same, is disclosed in co-pending patent application Ser. No. 16/904,926, entitled “Pultrusion of Profiles Having Non-Uniform Cross Sections,” which is incorporated herein by reference.

In one embodiment, the metallic leading edge weight portion 122 comprises a metallic stranded wire rope. Steel or stainless steel wire rope can be spooled so it can be fed into the pultrusion machine much like the fiber. The wire rope is textured on the outside due to the wire rope being made from twisted strands so it mechanically adheres well to the carbon fiber fill leading edge weight portion 124. In other words, the surface irregularity of a wire rope metallic leading edge weight portion 122 meshes well with the surrounding composite structure of carbon fiber fill leading edge weight portion 124.

The wire rope is typically available in long lengths so there is no need for joints, and the wire rope can be continuously feed into the pultrusion machine by pulling it off a spool. An example flexible wire rope configuration is 7×19 strands, but other wire rope variations can also be used. In a further embodiment, the wire rope is vapor degreased before insertion into the pultrusion machine for better bonding.

In an alternative embodiment, metallic leading edge weight portion 122 comprises a plurality of small diameter wire rods to approximate wire rope or strands. The number of small wire rods required depends on the cross sectional area. The number of rods used should be approximately equal to a single rod metallic leading edge weight portion 122.

Root End Fitting

FIG. 2 illustrates a root end fitting 200 that facilitates connection of the integrated composite airfoil profile 100 to the rotor hub assembly of an aircraft (not shown) with fasteners 230. Root end fitting 200 is comprised of a machined or forged root end stub 210 with doubler plates 220 and fasteners 230.

In one embodiment, doubler plates 220 can be made of composite materials or machined metal and can be laminated or bonded to the outside of integrated composite airfoil profile 100. Fasteners 230 can be through bolt fasteners connected through the entire integrated composite airfoil profile 100 or threaded bolts into the root fitting 200. Wet adhesive can be incorporated with the fasteners 230 to fill voids, add strength and improve the fatigue performance of the fasteners 230.

Connection of the root end fitting 200 to the integrated composite airfoil profile 100 is based on three engineering principles, including that insertion creates an over-lap to handle bending loads, the fasteners 230 handle centrifugal and bending loads, and the clamping force between the metallic components and the composite handles both bending loads and centrifugal loads and provides redundant transfer of loads from integrated composite airfoil profile 100 to root end fitting 200.

As shown in FIG. 2, in one embodiment, the integrated composite airfoil profile 100 also has dimension 2000, and the root end fitting has dimensions 2100 and 2200. In one embodiment, integrated composite airfoil profile 100 has dimension 2000 of approximately 18 feet, and the root end fitting has dimension 2100 of approximately 1.75 inches, and dimension 2200 of approximately 9 inches.

As an alternative embodiment, doubler plates 220 can comprise composite root end doublers that can be incorporated into the root end fitting 200 shown in FIG. 2. The composite root end doublers would be larger than the metallic doubler plates to spread out stress. The composite root end doublers can be made by conventional composite processes but must be shaped to fit with integrated composite airfoil profile 100. In an example embodiment, composite root end doublers are bonded in place before the root end fitting 200 is assembled in place.

### Alternative Pultruded Airfoil Embodiments

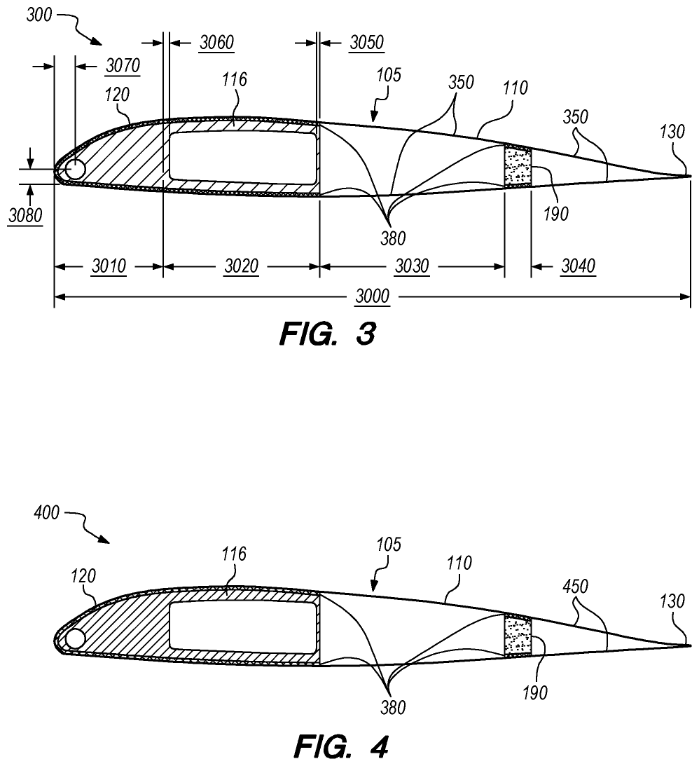

FIG. 3 illustrates as an alternative integrated composite airfoil profile 300. In integrated composite airfoil profile 300 the outer skin 150 comprises a metal skin 350 that is subsequently bonded around and to integrated composite airfoil profile 300. This alternate embodiment is useful, for example, in applications where severe sand erosion is an operational concern. The metal skin 350 provides better protection against severe sand erosion.

Materials such as titanium sheet, aluminum sheet, and stainless steel sheet stock can be used for metallic skin 350. In one embodiment, metallic skin 350 comprises 0.040 inch thick titanium sheet metal. The sheet stock is formed into a U-like shape and then formed over pultruded leading edge weight 120 and spar structure 105 including spar web 110 and spar box 116. Then the sheet stock is bonded in place with adhesive film layer 380. The metallic skins 350 can be welded, riveted or adhesively bonded together at the trailing edge weight 130.

As shown in FIG. 3, in one embodiment, the integrated composite airfoil profile 300 also has dimensions 3000, 3010, 3020, 3030, 3040, 3050, 3060, 3070, and 3080. In one embodiment, integrated composite airfoil profile 300 has dimension 3000 of approximately 12 inches, dimension 3010 of approximately 2 inches, dimension 3020 of approximately 3 inches, dimension 3030 of approximately 4 inches, dimension 3040 of approximately 0.5 inches, dimension 3050 of approximately 0.05 inches, dimension 3060 of approximately 0.187 inches, dimension 3070 of approximately 0.4 inches, and dimension 3080 of approximately 0.3 inches.

FIG. 4 illustrates another alternative integrated composite airfoil profile 400 where the outer skin 150 comprises a thermoplastic composite skin 450 that is formed and bonded over pultruded leading edge weight 120 and spar structure 105 including spar web 110 and spar box 116. Thermoplastic composite skin 450 has improved impact damage tolerance over thermoset composites.

In one embodiment, the thermoplastic composite skin 450 is manufactured by a press forming or continuous belt laminating process. The thermoplastic composite skin 450 can be made from fiberglass, carbon fiber cloth, or hybrid combinations thereof with a Polyetheretherketone (PEEK), Polyphenylene Sulfide (PPS), or Polyetherimide (PEI) thermoplastic matrix. The thermoplastic composite skin 450 can also have a tedlar (polyvinyl fluoride) film co-laminated that eliminates the need for paint and provides excellent UV and weathering resistance. In one embodiment, the thermoplastic composite skin 450 comprises 0.040 inch thick woven carbon cloth and PPS pre-consolidated formed sheets.

The thermoplastic composite skin 450 is subsequently thermo-formed to the pultruded leading edge weight 120 of the integrated composite airfoil profile 400 creating a U-like shape. The U-like shaped thermoplastic composite skin 450 is then formed around and bonded to spar web 110 and spar box 116. The thermoplastic composite skin 450 can be thermoplastic or induction welded at trailing edge weight 130 to join together the two sides together.

While thermoplastic composite skin 450 can be specially treated to bond to spar web 110 and spar box 116, an alternative embodiment to make an effective bond between thermoplastic composite skin 450, spar web 110, and spar box 116 is to laminate a synthetic veil material to the inner side of the thermoplastic composite skin 450. The synthetic veil material partially embeds in the thermoplastic composite skin 450 when it is processed. When the thermoplastic composite skin 450 is subsequently wrapped around spar web 110 and spar box 116, the synthetic veil material creates an effective tie between the thermoplastic composite skin 450, spar web 110, and spar box 116.

In one embodiment, integrated composite airfoil profile 400 has the same dimensions as integrated composite airfoil profile 300.

High Density Powder Leading Edge Weight

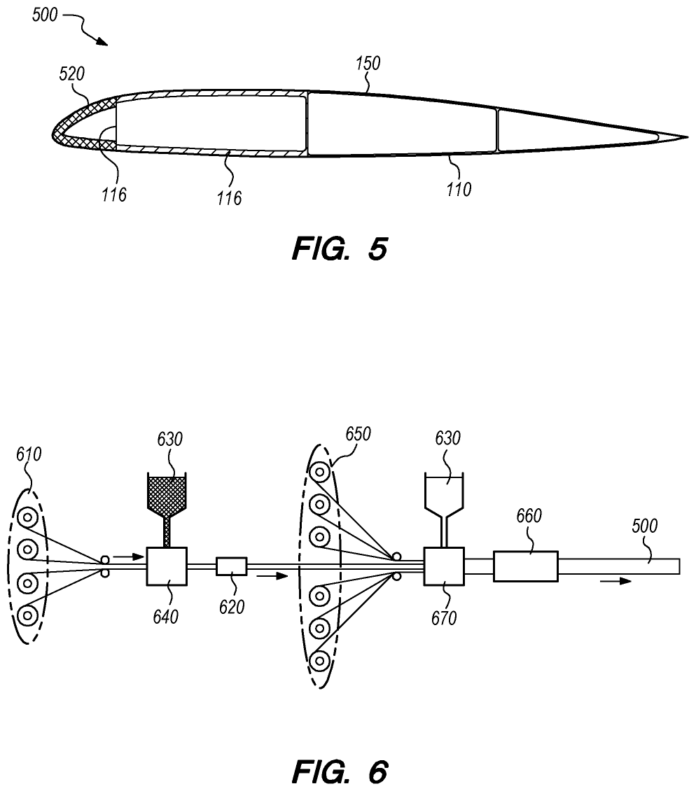

FIG. 5 illustrates another alternative integrated composite airfoil profile 500. As shown in FIG. 5, integrated composite airfoil profile 500 includes spar web 110, spar box 116, leading edge weight 520, and outer skin 150. Leading edge weight 520 comprises fiber reinforcement impregnated with matrix resin that is loaded with high density powder, such as tungsten or ceramic.

The leading edge weight 520 can be cured in the same die as the rest of the integrated composite airfoil profile 100, or, if cross-contamination of the matrix resin is a concern, the leading edge weight 520 can be cured in a separate die upstream of the rest of the integrated composite airfoil profile 100 as shown in FIG. 6. Because tungsten has a specific gravity of approximately 19 g/cm³, the leading edge weight 520 can have a density approximating that of steel. The coefficient of thermal expansion (CTE) of the leading edge weight 520 will be nearly identical to the rest of the integrated composite airfoil profile 100. Further, there is no concern about bonding between the leading edge weight 520 and the rest of the integrated composite airfoil profile 500 when using matrix resin that is loaded with high density powder because it is particles dispersed in the cured resin as compared to a smooth steel rod that could slide in the cured laminate due to centrifugal force and flexing of the integrated composite airfoil profile 500.

Furthermore, including high density metallic powder or particles in the pultrusion process for leading edge weight 520 offers more design flexibility than a steel rod. For example, an airfoil cross section may have a leading edge weight 520 made as a shaped element conforming to the airfoil shape or a solid slug with many different geometric variations possible.

Pultrusion Tooling and Process for Airfoil Profile 500

FIG. 6 illustrates pultrusion tooling 600, and the corresponding process, for making integrated composite airfoil profile 500. A typical pultrusion machine known in the art can be used with the pultrusion tooling 600 as long as the pultrusion machine has the pulling capacity and capability to handle the desired size of the integrated composite airfoil profile 500.

The pultrusion tooling 600 comprises a leading edge reinforcement station 610, a leading edge weight die 620, first resin impregnation station 640 for injection of matrix resin from resin holder 630 into the leading edge weight die 620, airfoil reinforcement 650, airfoil die 660, and a second resin impregnation station 670 for injection of matrix resin from resin holder 630 into the airfoil die 660.

In one embodiment, matrix resin in the first resin impregnation station 640 comprises matrix resin that is loaded with high density powder, such as tungsten or ceramic. Matrix resin in the second resin impregnation station 670 comprises matrix resign that is not loaded with high density powder.

The pultrusion tooling 600 system illustrated in FIG. 6 is particularly well suited for manufacture of integrated composite airfoil profile 500 where the leading edge weight 520 is cured in a separate die upstream of the rest of the integrated composite airfoil profile 500, for example, to add matrix resign that is loaded with high density powder to the leading edge weight 520. However, it can be used to manufacture any of integrated composite airfoil profile 100, 300, or 400 where the leading edge weight 120 is cured in a separate die upstream from the rest of integrated composite airfoil profile 100, 300, or 400.

Aerodynamic Twist

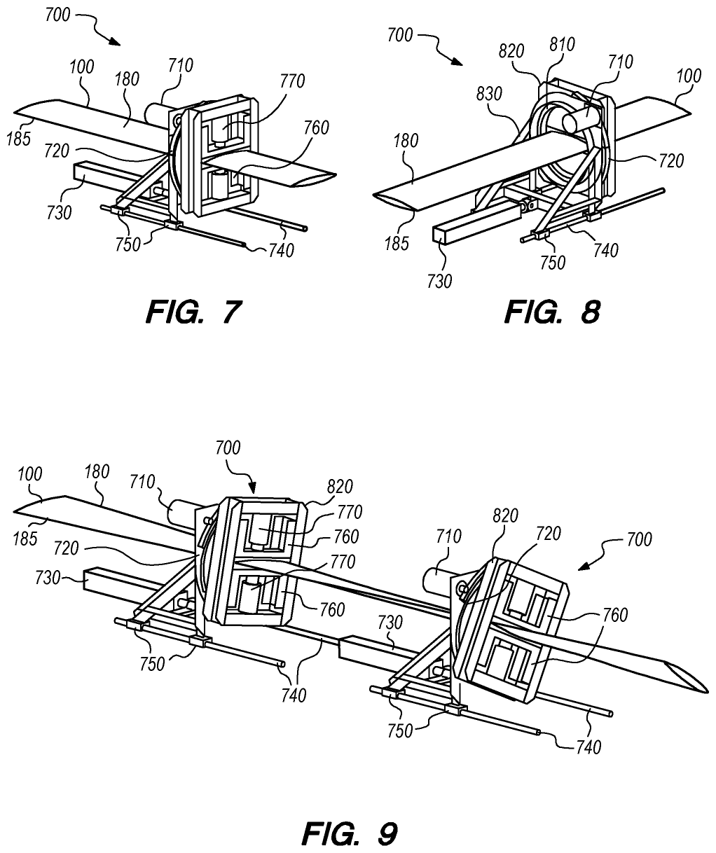

Turning to FIGS. 7-9, there is the potential to build aerodynamic twist into integrated composite airfoil profile 100 along the span-wise length of the integrated composite airfoil profile 100 by using gripper puller 700. In addition, while this potential to build aerodynamic twist into airfoil profile is described herein for integrated composite airfoil profile 100, it can also be used for any of integrated composite airfoil profile 300, 400, or 500, or for other airfoil profiles.

Factors that will affect the variability in aerodynamic twist continuously induced as the integrated composite airfoil profile 100 exits the pultrusion die can include: (1) the amount of mechanical roll at the gripper puller 700 plus and minus from horizontal; (2) the distance of the gripper puller 700 from the pultrusion die; (3) the position of the cure zone for the integrated composite airfoil profile 100 in the pultrusion die; the pultrusion die heat level and heat profile along the length of the die; and (4) the pultrusion line speed.

In one embodiment, gripper puller 700 can be utilized to build aerodynamic twist into integrated composite airfoil profile 100. The integrated composite airfoil profile 100 coming off the pultrusion machine is loaded into a gripper puller 700 which supports the root end 180 (see FIG. 1) of the integrated composite airfoil profile 100 and mechanically induces a twist into the integrated composite airfoil profile 100 at the tip end 186.

FIGS. 7 and 8 illustrate an embodiment of the design of the gripper puller 700 comprising twist actuator 710, gear selector 720, pull actuator 730, linear guide rails 740, linear guides 750, gripper jaws 760, gripper actuator 770, bearing 810, gripper frame 820, and puller frame 830.

The gripper puller 700 is supported on linear guide rails 740 by linear guides 750, and driven along linear guide rails 740 by the pull actuator 730. The gripper frame 820 is attached to the puller frame 830 with large diameter bearing 810, allowing gripper frame 820 to rotate relative to the puller frame 830. The twist actuator 710 drives the rotary motion of the gripper frame 820 via the gear selector 720.

At the beginning of the pull cycle using the gripper puller 700, the pull actuator 730 retracts fully, the gripper frame 820 rotates to align with the integrated composite airfoil profile 100, and the gripper jaws 760 clamp the integrated composite airfoil profile 100. As the pull actuator 730 drives the gripper puller 700 along the linear rails 740, the twist actuator 710 rotates the gripper frame 820, causing integrated composite airfoil profile 100 to twist to build aerodynamic twist into integrated composite airfoil profile 100 along the span-wise length of integrated composite airfoil profile 100.

As shown in FIG. 9, in a further embodiment, two gripper pullers 700 can be used in tandem to build aerodynamic twist into integrated composite airfoil profile 100. In this embodiment, each gripper puller 700 pulls and twists the integrated composite airfoil profile 100 in turn, then returns to its starting position to repeat the cycle. This way, one gripper puller 700 is always pulling while the other gripper puller 700 returns to its home position. Thus, integrated composite airfoil profile 100 is continuously being pulled through the die, and there is less chance of sticking in the die.

The gripper puller 700 that is opening to travel back for a new pull cycle sequence must open wide enough to clear the twisted integrated composite airfoil profile 100. The other gripper puller 700 must be controlled so it closes at the same roll angle as the integrated composite airfoil profile 100 that it is closing on.

The distance between the gripper puller 700 and the pultrusion die would typically be fixed for the pultrusion machine design, but in an alternative embodiment, a computer numerical control (CNC) machine and software can manage the distance and the other variables. The incorporation of in-process, non-destructive inspection (NDI) technology can also be used to create a closed loop control system for both inducing aerodynamic twist and managing the process for repeatable results.

In a further embodiment, the gripper puller 700 can be mounted to linear guide rails 740 but with a roll axis pivot on centerline. Servo-motor controlled ball screws can manipulate the gripper puller roll in both directions from horizontal. The roll deflection of the gripper puller 700 feeds all the way back to integrated composite airfoil profile 100 and a progressive set is created as the resin continuously gels near the pultrusion die. Normally, the pull load line for pultrusion is aligned with the die in three axes (e.g., the axial, vertical, and horizontal axes) to the pull load line. The pull load line is fixed by the reciprocating gripper puller's 700 alignment with the pultrusion die. However, if a roll axis from horizontal is incorporated in the gripper puller 700 with respect to the pull line load, it creates the ability to continuously induce a twist in the integrated composite airfoil profile 100 as it is pultruded.

### Additional Features and Options

In various embodiments, additional features and options can be incorporated into integrated composite airfoil profile 100. In addition, while these additional features and options are described herein for integrated composite airfoil profile 100, these additional features and options can also be used alone or in combination for any of integrated composite airfoil profile 300, 400, or 500.

Foam Insert 190—In a further alternative embodiment, a foam insert 190 (see FIGS. 3 and 4) can be inserted in integrated composite airfoil profile 100 to increase strength and stiffness of the integrated composite airfoil profile 100 while keeping the trailing edge portion of integrated composite airfoil profile 100 as light as possible. Foam inset 190 can be glued in place to support skin stiffening web ribs 140 to support outer skin 150.

Lightning Strike Protection—Fine mesh (for example 200 by 200) metallic wire screen, or mesh, is a known to provide lightning protection for composite aircraft and rotor wing or blade structures. In one embodiment, such wire screen can be continuously formed and inserted into the pultrusion process for the integrated composite airfoil profile 100 such that the metallic wire screen becomes part of integrated composite airfoil profile 100 without the need for secondary bonding operations.

Surface Cosmetics and Environmental Protection—Conventional paint is a complication for high-rate production and raises environmental concerns. In one embodiment, printed and/or colored synthetic surfacing veils are continuously fed and inserted into the pultrusion process to color and environmentally protect integrated composite airfoil profile 100.

In another embodiment, the exterior of integrated composite airfoil profile 100 is continuously coated by injection of an “in-mold” polymer coating into the downstream portion of the pultrusion die as integrated composite airfoil profile 100 exits the die. In a further embodiment, a second die can serve as the coating die downstream of the primary pultrusion die.

In the various embodiments, the coating portion of the primary die or the coating die should have a slightly larger contour, and in one example, on the order of 0.010 inches larger, than the outer skin 150 to create space for the in-mold coating thickness.

Leading Edge Erosion Protection—In a further embodiment, a metallic leading edge cuff as known in the art can be bonded to integrated composite airfoil profile 100 to provide rain and sand or debris erosion protection for integrated composite airfoil profile 100. As integrated composite airfoil profile 100 spins around the rotor, leading edge weight 120 is subjected to elements that can cause erosion because if there is sand or debris in the air, or kicked up by the rotors, it hits these particles. The result is erosion of the fibers and resin of leading edge weight 120. Therefore, a metallic leading edge cuff can be bonded on leading edge weight 120 to lessen the erosion. Outer skin 150 can be designed to have a relief or set-back to accommodate the thickness of the metallic leading edge cuff without interrupting the airfoil shape and performance.

An alternative embodiment is to apply an ultra-high molecular weight polymer film with adhesive to leading edge weight 120 of integrated composite airfoil profile 100 for erosion protection. In one embodiment, polymer materials such as UHMW PE can be used.

While the invention has been specifically described in connection with certain specific embodiments thereof, it is to be understood that this is by way of illustration and not of limitation. Reasonable variation and modification are possible within the scope of the foregoing disclosure and drawings without departing from the spirit of the invention.

We claim:

1- An integrated composite airfoil profile comprising:
A spar structure comprising:
a spar web; and
a spar box;
a leading edge weight;
an outer skin;
a plurality of web ribs for stiffening and supporting the outer skin; and
wherein the leading edge weight, the spar structure, and the plurality of web ribs are integrated during pultrusion to form the integrated composite airfoil profile.

2- The integrated composite airfoil profile of claim 1 wherein the leading edge weight comprises:
a metallic leading edge weight portion; and
a carbon fiber fill leading edge weight portion.

3- The integrated composite airfoil profile of claim 2 wherein the metallic leading edge weight portion further comprises a metallic stranded wire rope.

4- The integrated composite airfoil profile of claim 2 wherein the metallic leading edge weight portion further comprises a plurality of wire rods.

5- The integrated composite airfoil profile of claim 1 wherein the outer skin comprises a composite fabric ply wherein the composite fabric ply is wrapped around the leading edge weight and the spar structure.

6- The integrated composite airfoil profile of claim 5 wherein the fabric ply comprises a non-woven carbon fiber fabric.

7- The integrated composite airfoil profile of claim 1 further comprising a root end fitting for correcting the integrated composite airfoil profile to a rotor hub of an aircraft, the root end fitting comprising:
a doubler plate; and
a root end stub.

8- The integrated composite airfoil profile of claim 7 wherein the doubler plate comprises a metallic doubler plate.

9- The integrated composite airfoil profile of claim 7 wherein the doubler plate comprises a composite doubler plate.

10- The integrated composite airfoil profile of claim 1 wherein the outer skin comprises a metal skin, and wherein the metal skin is bonded to the leading edge weight and the spar structure.

11- The integrated composite airfoil profile of claim 1 wherein the outer skin comprises a thermoplastic composite skin, and wherein the thermoplastic composite skin is bonded to the leading edge weight and the spar structure.

12- The integrated composite airfoil profile of claim 11 wherein the thermoplastic composite skin further comprises an outer side and an inner side, the inner side comprising a synthetic veil material.

13- The integrated composite airfoil profile of claim 1 wherein the leading edge weight comprises a fiber reinforcement impregnated with a matrix resin.

14- The integrated composite airfoil profile of claim 1 further comprising a wire mesh screen for lightning strike protection.

15- The integrated composite airfoil profile of claim 1 further comprising an exterior synthetic surfacing veil.

16- The integrated composite airfoil profile of claim 1 further comprising a foam insert to support the skin stiffening web ribs.

17- The integrated composite airfoil profile of claim 1 further comprising a metallic leading edge cuff, and wherein the metallic leading edge cuff is bonded to the leading edge weight and the spar structure.

18- A pultrusion tooling system for pultruding an integrated composite airfoil profile comprising:
a leading edge reinforcement station;
a leading edge weight die;
a first resin impregnation station for injection of a matrix resin loaded with high density powder into the leading edge weight die;
an airfoil reinforcement station;
an airfoil die; and
a second resin impregnation station for injection of a matrix resin not loaded with high density powder into the airfoil die.

19- A gripper puller for creating aerodynamic twist in an airfoil profile comprising:
a puller frame;
a gripper frame, wherein the gripper frame is attached to the puller frame with a bearing, and wherein the gripper frame rotates relative to the puller frame;
a gripper jaw to secure an airfoil profile in the gripper frame;
a linear guide rail for supporting the gripper frame and puller frame;
a pull actuator for driving the gripper frame and the puller frame along the linear guide rail;
a twist actuator for rotating the gripper frame; and
wherein as the pull actuator drives the gripper frame and puller frame along the linear rail, the twist actuator rotates the gripper frame causing the airfoil profile to twist to build aerodynamic twist into the airfoil profile.
